(19) United States
(12) Patent Application Publication
(10) Pub. No.: US 2026/0246684 A1
(43) Pub. Date: Aug. 20, 2026

(54) SIGNAL PROCESSING APPARATUS

(71) Applicant: NEC Corporation, Tokyo (JP)

(72) Inventor: Atsufumi Shibayama, Tokyo (JP)

(73) Assignee: NEC Corporation, Tokyo (JP)

(21) Appl. No.: 19/533,429

(22) Filed: Feb. 9, 2026

(30) Foreign Application Priority Data
Feb. 14, 2025 (JP) 2025-022528

(51) Int. Cl. H04L 27/26

(52) U.S. Cl. CPC H04L 27/2628; H04L 27/26134

(57) ABSTRACT

A signal processing apparatus that performs inverse fast Fourier transform (IFFT) on N pieces of input data where N is a positive integer greater than or equal to 3 and not a power of 2, includes a butterfly operation processing circuit configured to perform butterfly operation processing on the input data, a converted twiddle factor operation processing circuit configured to perform twiddle factor operation processing using a converted twiddle factor coefficient obtained by multiplying a twiddle factor operation coefficient for IFFT by M/N, a 1/M operation circuit configured to perform 1/M operation, where M is a power of 2, on output data to output the result of the operation.

### CROSS REFERENCE TO RELATED APPLICATIONS

The present application is based upon and claims the benefit of the priority of Japanese patent application No. 2025-022528, filed on Feb. 14, 2025, the disclosure of which is incorporated herein in its entirety by reference thereto.

The present disclosure relates to a signal processing apparatus, a signal processing method, and a non-transitory medium.

### FIELD

### Background

In digital signal processing, a fast Fourier transform (FFT) is used as one of key processing. For example, a frequency-domain equalization (FDE) is known as a waveform distortion compensation technology to compensate a waveform distortion of a signal transmitted in wireless or wired communication. In the frequency-domain equalization, first, a plurality of pieces of time-domain signal data are subjected to FFT processing to be transformed into a plurality of pieces of frequency-domain data, which are subjected to filtering for equalization. Then, a plurality of pieces of the filtered frequency-domain-data are subjected to inverse fast Fourier transform (IFFT) processing to be transformed into a plurality of pieces time-domain signal data, i.e., data with a waveform distortion in the original time-domain signal data compensated. It is noted that when there is no need to distinguish between FFT and IFFT, “FFT/IFFT” may be used.

Generally, “butterfly operation” is used in FFT/IFFT processing. For example, Reference Literature 1 discloses an FFT apparatus that employs a butterfly operation(s). Reference Literature 1 also discloses a twiddle factor operation(s) which will be described later, namely multiplication using a twiddle coefficient (a complex number, termed as twiddle operation coefficient or twiddle factor). Non-Patent Literature 1 discloses the Cooley-Tukey butterfly algorithm as an efficient FFT/IFFT processing. For example, Reference Literature 2 discloses a Prime Factor algorithm as one of efficient FFT/IFFT processing methods.

FIG. 12 illustrates an example of a data flow 500 of 64-point FFT processing decomposed into two-stages of radix-8 butterfly operations using the Cooley-Tukey algorithm. FIG. 12 is a diagram illustrating one of typical FFT processing with butterfly operations based on the Cooley-Tukey algorithm. The data flow 500 includes a total of sixteen radix-8 butterfly operations: eight radix-8 butterfly operations 502-1 to 502-8 in a first stage and eight radix-8 butterfly operations 503-1 to 503-8 in a second stage. The data flow 500 also includes a twiddle factor operation 504 that multiplies twiddle operation coefficients W(k), where W(k)=exp(−2πjk/N(=64)), j×j=−1 (i.e., j=\sqrt{−1}), for k=0 to N−1. There is a case where W(k) is denoted as W_{N}^{k}, using W_{N}=exp(−2πj/N). As illustrated in FIG. 12, the twiddle operation coefficients are (W(0), W(0), . . . , W(0)), (W(0), W(1), W(2), . . . , W(7)), (W(0), W(2), W(4), . . . , W(14)), . . . , (W(0), W(7),W(14), . . . , W(49)). In the data flow 500 in FIG. 12, the input time-domain data x(n) (n=0, 1, . . . , 63) are transformed into the frequency-domain signal X(k) (k=0, 1, . . . , 63) via a fast Fourier transform. It is noted that in FIG. 12, a part of the data flow is omitted only for the sake of drawing.

The data flow 500 illustrated in FIG. 12, even when performing IFFT processing, employs the same basic configuration and butterfly operation processing, but has a different twiddle direction (phase rotation direction) of the twiddle factor operation. Furthermore, in IFFT processing, when the number of points is N (where N is a positive integer), multiplication by 1/N or division by N operation (1/N scaling) applied to each data value is added.

FIG. 13 illustrates a data flow 510 of 64-point IFFT processing decomposed into two-stages of radix-8 butterfly operations using the Cooley-Tukey algorithm. FIG. 13 is a diagram illustrating one of typical IFFT processing with butterfly operations based on the Cooley-Tukey algorithm. The data flow 510 includes a total of sixteen radix-8 butterfly operations: eight radix-8 butterfly operations 512-1 to 512-8 in the first stage and eight radix-8 butterfly operations 513-1 to 513-8 in the second stage. It also includes twiddle factor operation coefficient W(k) (W(k)=exp(2πjk/N), j×j=−1) in twiddle factor operation 514 (in FIG. 13, the twiddle operation coefficients are (W(0), W(0), . . . , W(0)), (W(0), W(1), . . . , W(7)), . . . , (W(0), W(7), . . . , W(49)), and a 1/N operation 515 that performs operation 1/64 (multiplication by 1/64 or division by 64).

The twiddle coefficient W(k) in the IFFT processing has an opposite sign to the twiddle coefficient in the FFT processing, and therefore the twiddle direction is reversed. In the data flow 510 illustrated in FIG. 13, 64-point input frequency data X(k) (k=0, 1, . . . , 63), are subjected to an inverse fast Fourier transform (IFFT) to be transformed into the 64-point time-domain signal x(n) (n=0, 1, . . . , 63). It is noted that a part of the data flow is omitted from the illustration in FIG. 13.

In FIG. 12 and FIG. 13, the configurations of the FFT processing and the IFFT processing with a number of points N=64 (=2\hat{ }6) are illustrated. FFT processing and IFFT processing with a number of points N that is other than a power of 2 can also be implemented using the same basic configuration.

FIG. 14 illustrates a data flow 520 of 72-point IFFT processing decomposed into two stages using the Cooley-Tukey algorithm: a radix-8 butterfly process and a radix-9 butterfly process. FIG. 14 is a diagram illustrating one of typical N-points IFFT processing with butterfly operations based on the Cooley-Tukey algorithm, where N is not a power of 2. The data flow 520 includes nine radix-8 butterfly operations 522-1 to 522-9 in the first stage and eight radix-9 butterfly operations 523-1 to 523-8 in the second stage. The data flow 520 also includes a twiddle factor operation 524 that multiplies by a twiddle operation coefficients W(k) (W(k)=exp(2πjk/N), j×j=−1) (in FIG. 14, the twiddle operation coefficients include (W(0), W(0), . . . , W(0)), (W(0), W(1), . . . , W(8)), . . . , (W(0), W(7), . . . , W(56)), and a 1/N operation 525 that performs an operation 1/72 to obtain 72 points of output data ((x(0), x(8), . . . , x(64), (x(1),x(9), . . . , x(65), . . . , (x(7),x(15), . . . , x(71)).

In the data flow 520 illustrated in FIG. 14, 72 points of input frequency data X(k) (k=0, 1, . . . , 71) are subjected to IFFT processing and is transformed into 72 points of time-domain signal data x(n) (n=0, 1, . . . , 71). It is noted that a part of the data flow is omitted from the illustration in FIG. 14.

### [NPL 1]

J. W. Cooley, J. W. Tukey, “An Algorithm for the Machine Calculation of Complex Fourier Series”, Mathematics of Computation, US, American Mathematical Society, April 1965, Vol. 19, No. 90, pp. 297-301

### SUMMARY

In the N-point IFFT processing where N is a power of 2, the operation of calculating 1/N can be implemented by using a shift operation, rather than using division by N or multiplication by 1/N. Specifically, when the number of points N in the IFFT processing is a n-th power of 2, i.e., N=2\hat{ }n (where n is a positive integer, and A indicates an exponent operation) and signal data is represented in a fixed-point format, the calculation of 1/N of the signal data can be implemented by an n-bit right shift operation on the signal data. Alternatively, when the signal data is represented in a floating-point format, the calculation of 1/N of the signal data can be implemented by subtraction of n from an exponent part of the signal data.

For example, in the 64-point IFFT processing illustrated in FIG. 13, the 1/64 operation can be implemented either by shifting the signal data 6 bits to the right or by subtracting 6 from the exponent part of the signal data. Therefore, in an IFFT circuit configure to perform N-point IFFT processing where N is a power of 2, the 1/N operation unit can be implemented using a shift circuit or a subtraction circuit, each having a smaller circuit size and a lower power consumption than those of a division circuit or a multiplication circuit.

On the other hand, in a case of N-point IFFT where Nis a positive integer other than a power of 2, the operation of calculating 1/N cannot be implemented using a shift operation or the like. Therefore, the operation of calculating 1/N needs to be implemented using either division by N or multiplication by 1/N.

For example, in the 72-point IFFT processing illustrated in FIG. 14, the 1/72 operation must be implemented either by division by 72 or by multiplication by 1/72. The 1/N calculation unit in an IFFT circuit that implements an N-point IFFT processing where N is a positive integer other than a power of 2 has a larger circuit size and higher power consumption as compared with the 1/N calculation unit in an IFFT circuit that implements an N-point IFFT processing where N is a power of 2. As a result, the IFFT circuit that implement an N-point IFFT where Nis a positive integer other than a power of 2 suffers from the problem that it has larger circuit sizes and higher power consumption as compared with the IFFT circuit that implement an N-point IFFT where Nis a power of 2. A signal processing apparatus equipped with a digital filter circuit that implements frequency-domain equalization processing using an N-point IFFT processing where N is a positive integer other than a power of 2 has a problem that it has a larger circuit size and higher power consumption, as compared with a signal processing apparatus equipped with a digital filter circuit that implements frequency-domain equalization processing using an N-point IFFT processing where N is a power of 2.

Therefore, one of objects of the present disclosure is to provide a signal processing apparatus, a signal processing method, and a non-transitory medium each enabling to reduce, or suppress increase in, a circuit scale and a power consumption.

According to one aspect of the present disclosure, a signal processing apparatus performs an inverse fast Fourier transform (IFFT) on N pieces of input data, where N is a positive integer greater than or equal to 3 and not a power of 2. The signal processing apparatus includes a butterfly operation processing circuit configured to perform butterfly operation processing on the N pieces of input data; a converted twiddle factor operation processing circuit configured to perform twiddle factor operation processing using converted twiddle factor coefficients, each obtained by multiplying each original twiddle factor coefficient for the IFFT by M/N; and a 1/M operation circuit configured to perform 1/M operation processing on N pieces of output data, where M is a power of 2, to output result of the operation as N-points of output data of the IFFT.

According to one aspect of the present disclosure, a signal processing apparatus includes a fast Fourier transform apparatus configured to perform a fast Fourier transform (FFT) on every consecutive N pieces of input time-domain data where N is a positive integer, not a power of 2; a converted filter operation apparatus configured to multiply each of N pieces of frequency-domain data generated by the fast Fourier transform apparatus by each converted filter coefficient obtained by multiplying each filter coefficient for frequency-domain equalization by (M/N), where M is a power of 2; and an inverse fast Fourier transform apparatus that receives N pieces of frequency-domain data output from the converted filter processing apparatus to perform an inverse fast Fourier transform (IFFT) on the N pieces of frequency-domain data. The inverse fast Fourier transform apparatus includes a butterfly operation processing circuit configured to perform butterfly operation processing on the N pieces of frequency-domain data; a twiddle factor operation processing circuit configured to perform twiddle factor operation processing using twiddle factor coefficients for the IFFT; and a 1/M operation circuit configured to perform 1/M operation processing on N pieces of output data to output the result of the operation.

A method according to one aspect of the present disclosure includes
performing an inverse fast Fourier transform (IFFT) processing on N pieces of input data, where N is a positive integer greater than or equal to 3 and not a power of 2, wherein the IFFT processing includes
performing butterfly operation processing on the N pieces of input data;
performing twiddle factor operation processing using converted twiddle factor coefficients, each obtained by multiplying each original twiddle factor coefficient for the IFFT by M/N; and
perform 1/M operation processing on N pieces of output data, where M is a power of 2, to output result of the operation as N-points of output data of the IFFT.

A method according to one aspect of the present disclosure includes
performing a fast Fourier transform (FFT) processing on every consecutive N pieces of input time-domain data where N is a positive integer, not a power of 2;
multiplying each of N pieces of frequency-domain data generated by the fast Fourier transform by each converted filter coefficient obtained by multiplying each filter coefficient for frequency-domain equalization by (M/N), where M is a power of 2; and
performing an inverse fast Fourier transform (IFFT) processing on the N pieces of frequency-domain data with the converted filter coefficients multiplied, wherein the inverse fast Fourier transform processing includes
performing butterfly operation processing on the N pieces of frequency-domain data;
performing twiddle factor operation processing using twiddle factor coefficients for the IFFT; and
performing 1/M operation processing on output data to output the result of the operation.

According to one aspect of the present disclosure, a non-transitory medium stores a program that causes a processor to execute:
performing an inverse fast Fourier transform (IFFT) processing on N pieces of input data, where N is a positive integer greater than or equal to 3 and not a power of 2, wherein the IFFT processing includes
performing butterfly operation processing on the N pieces of input data;
performing twiddle factor operation processing using converted twiddle factor coefficients, each obtained by multiplying each original twiddle factor coefficient for the IFFT by M/N; and
perform 1/M operation processing on N pieces of output data, where M is a power of 2, to output result of the operation as N-points of output data of the IFFT.

According to one aspect of the present disclosure, a non-transitory medium stores a program that causes a processor to execute:
performing a fast Fourier transform (FFT) processing on every consecutive N pieces of input time-domain data where N is a positive integer, not a power of 2;
multiplying each of N pieces of frequency-domain data generated by the fast Fourier transform by each converted filter coefficient obtained by multiplying each filter coefficient for frequency-domain equalization by (M/N), where M is a power of 2; and
performing an inverse fast Fourier transform (IFFT) processing on the N pieces of frequency-domain data with the converted filter coefficients multiplied, wherein the inverse fast Fourier transform processing includes
performing butterfly operation processing on the N pieces of frequency-domain data;
performing twiddle factor operation processing using twiddle factor coefficients for the IFFT; and
performing 1/M operation processing on output data to output the result of the operation.

According to present disclosure, it is possible to suppress increase in or reduce a circuit scale and a power consumption of a signal processing apparatus.

### BRIEF DESCRIPTION OF THE DRAWINGS

FIG. 1 is a diagram illustrating a data flow of IFFT processing of at least one embodiment of the present disclosure.

FIG. 2 is a diagram schematically illustrating an example configuration of an IFFT circuit of at least one embodiment of the present disclosure.

FIG. 3 is a diagram schematically illustrating an example configuration of a converted twiddle factor operation processing unit of at least one embodiment of the present disclosure.

FIG. 4 is a diagram schematically illustrating an example configuration of a complex multiplication circuit of at least one embodiment of the present disclosure.

FIG. 5 is a diagram schematically illustrating an example configuration of a digital filter circuit of at least one embodiment of the present disclosure.

FIG. 6 is a diagram schematically illustrating an example configuration of an FFT circuit of at least one embodiment of the present disclosure.

FIG. 7 is a diagram schematically illustrating an example configuration of an IFFT circuit of at least one embodiment of the present disclosure.

FIG. 8 is a diagram schematically illustrating an example configuration of a converted filter processing circuit of at least one embodiment of the present disclosure.

FIG. 9 is a diagram schematically illustrating an example configuration of a complex multiplication circuit of at least one embodiment of the present disclosure.

FIG. 10 is a diagram schematically illustrating an example configuration of a digital filter circuit of at least one embodiment of the present disclosure.

FIG. 11 is a diagram schematically illustrating an example configuration of an IFFT circuit of at least one embodiment of the present disclosure.

FIG. 12 is a diagram schematically illustrating an example of a data flow for 64-point FFT processing.

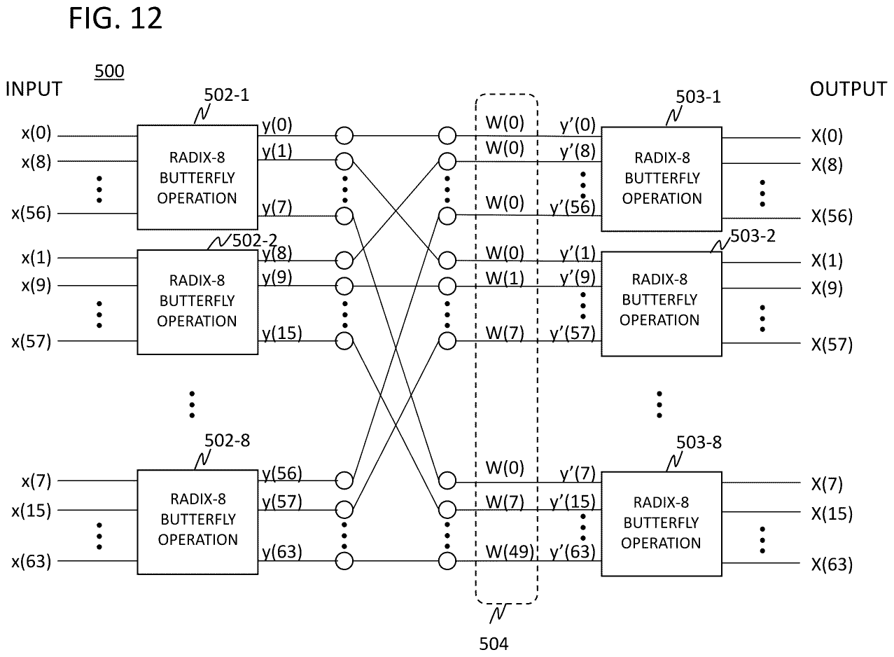

FIG. 13 is a diagram schematically illustrating an example of a data flow for 64-point IFFT processing.

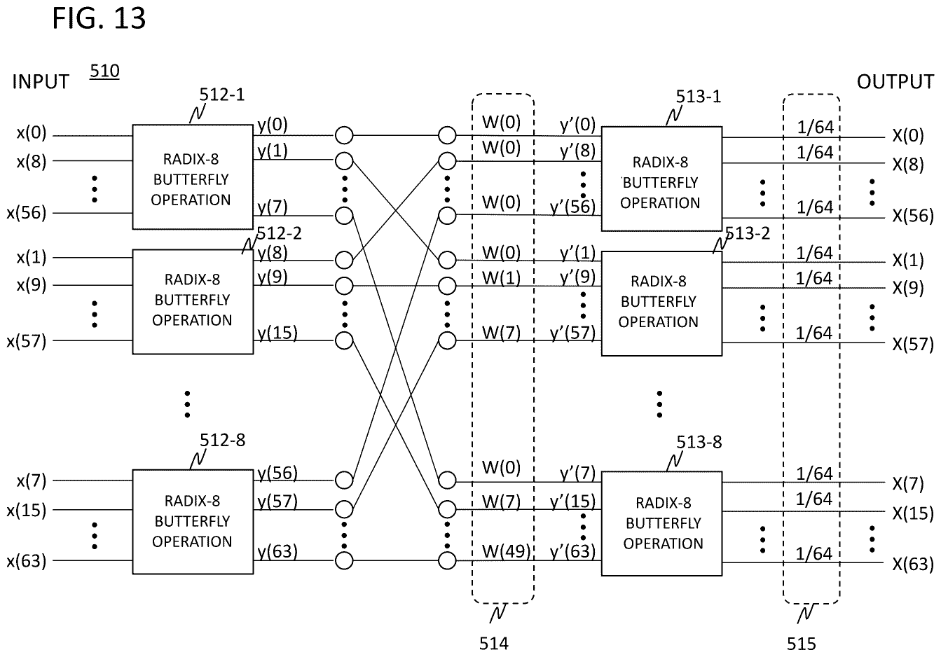

FIG. 14 is a diagram schematically illustrating an example of a data flow for 72-point IFFT processing.

FIG. 15 is a diagram schematically illustrating a signal flow graph for N(=9) point DFT.

FIG. 16 is a diagram schematically illustrating an alternative signal flow graph (radix 3) of FIG. 15.

FIG. 17 is a diagram schematically illustrating a signal flow graph for N(=9) point IDFT.

FIG. 18 is a diagram schematically illustrating implementation example on a signal processor.

### DETAILED DESCRIPTION

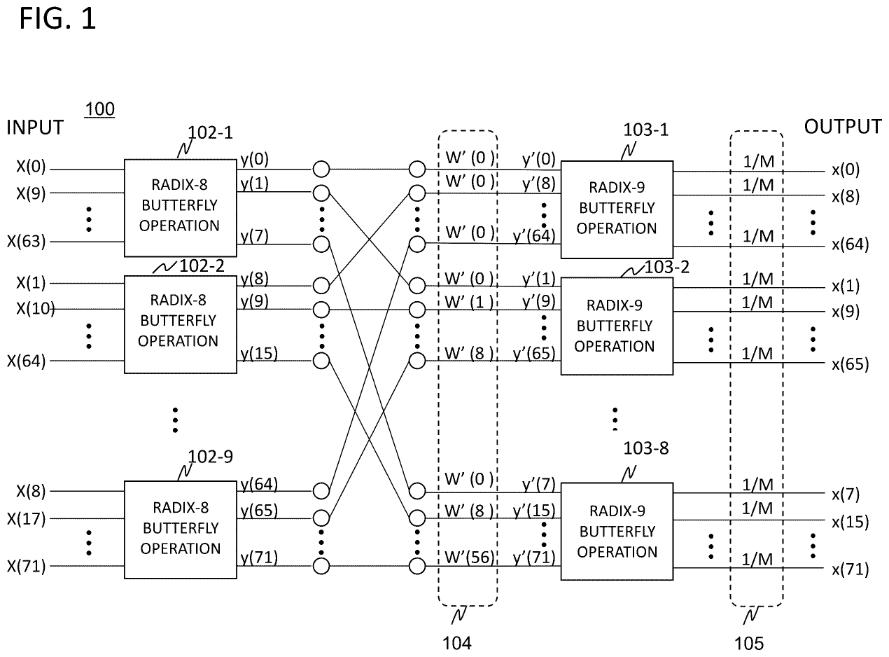

The following describes embodiments of the present disclosure with reference to the drawings. FIG. 1 is a diagram illustrating a data flow of IFFT processing according to at least one of embodiments of the present disclosure. In FIG. 1, the data flow 100 of 72-point IFFT processing is illustrated which is decomposed into two stages using the Cooley-Tukey algorithm: butterfly operation processing with a radix of 8 and butterfly operation processing with a radix of 9. More specifically, the data flow 100 includes butterfly operation processing including nine radix-8 butterfly operations 102-1 to 102-9 in the first stage and eight radix-9 butterfly operations 103-1 to 103-8 in the second stage, converted twiddle factor operation 104 configured to multiply converted twiddle operation coefficients W′(k) (W′(k)=W(k)×M/N, W(k)=exp(2πj*k/N), j×j=−1) to signal data and a 1/M operation 105 configured to perform 1/M operation, where N is a number of points for the IFFT, and M is a power of 2. In FIG. 1, (W′(0), W′(0), . . . , W′(0)), (W′(0), W′(1), . . . , W′(8)), . . . , (W′(0), W′(8), . . . , W′(56)) are the converted twiddle operation coefficients. The converted twiddle operation coefficient W′(k) is a coefficient obtained by multiplying an original twiddle coefficient W(k) (W(k)=exp(2πjk/N), j×j=−1) for N-point IFFT algorithm, by M/N. In the present embodiment, N=72, M=64, and M/N=64/72.

In the data flow 100 illustrated in FIG. 1, every 72 pieces of frequency-domain signal data X(k) (k=0, 1, . . . , 71) received are subjected to an inverse fast Fourier transform (IFFT) to produce 72 pieces of time-domain signal data x(n) (n=0, 1, . . . , 71). It is noted that for the sake of drawing convenience, a part of data flow is omitted in FIG. 1.

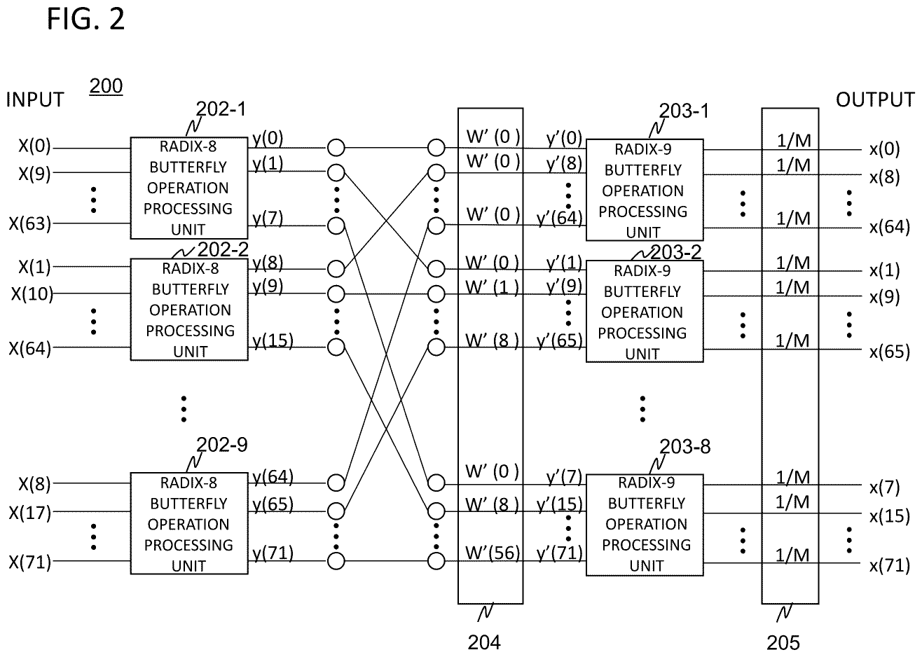

FIG. 2 illustrates an example configuration of an IFFT circuit that implements the data flow 100 of the IFFT processing illustrated in FIG. 1. Referring to FIG. 2, a 72-point IFFT circuit 200 is decomposed into two stages using the Cooley-Tukey algorithm: a radix-8 butterfly operation part and a radix-9 butterfly operation part.

The IFFT circuit 200 includes 9 radix-8 butterfly operation processing units 202-1 to 202-9 and 8 radix-9 butterfly operation processing units 203-1 to 203-8, a converted twiddle factor operation processing unit 204 that multiplies a converted twiddle operation coefficients W′(k) (W′(k)=W(k)×M/N, W(k)=exp(2πjk/N), j×j=−1) (in FIG. 2, the twiddle operation coefficients are (W′(0), W′(0), . . . , W′(0)), (W′(0), W′(1), . . . , W′(8)), . . . , (W′(0), W′(8), . . . , W′(56)), and a 1/M operation unit 205 that computes 1/M. These are circuits configured to perform processing corresponding respectively to the butterfly operation 102, the butterfly operation 103, the converted twiddle factor operation 104, and the 1/M operation 105 in the data flow 100 of FIG. 1. Nis the number of IFFT points, and M is a power of 2. The converted twiddle operation coefficient W′(k) is obtained by multiplying the original twiddle coefficient W(k) (W(k)=exp(2πjk/N), j×j=−1) for the N-point IFFT processing, by M/N.

In the present embodiment, N=72, M=64, and M/N=64/72. Since M is a power of 2, it is possible to implement the 1/M operation unit 205 using a circuit(s) with a small scale and a low power consumption, such as a right shift circuit. For example, in case where data is represented in a fixed-point format, the 1/M (M=64=2\hat{ }6) operation may be implemented by a 6-bit arithmetic right shift circuit. The arithmetic right shift is the same as a right shift except that the most significant bit is unchanged. In the arithmetic right shift, bits vacated by the right shift may be filled with a value of the most significant bit (MSB), which indicates a sign of a number in a two's-complement representation.

In the IFFT circuit 200 illustrated in FIG. 2, 72 pieces of frequency-domain signal data X(k) (k=0, 1, . . . , 71) are received and subjected to an IFFT processing to be transformed back to 72 pieces of time-domain signal data x(n) (n=0, 1, . . . , 71). It is noted that in FIG. 2, a part of data flow is omitted for the sake of drawing convenience.

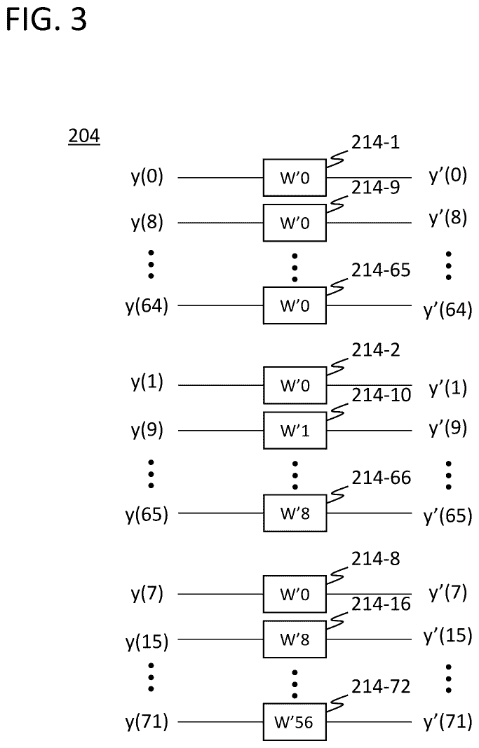

FIG. 3 is a diagram illustrating an example configuration of the converted twiddle factor operation processing unit 204 in FIG. 2. The converted twiddle factor operation processing unit 204 includes 72 complex multiplication circuits 214-1 to 214-72, corresponding to the number of IFFT points. The complex multiplication circuits 214-1 to 214-72 multiply the converted twiddle operation coefficient W′(k) (W′(k)=W(k)×M/N, W(k)=exp(2πjk/N), j×j=−1) by each signal data y (k) (k=0, 1, . . . 71), which is a result of the radix-8 butterfly operation processed by the butterfly operation processing units 202-1 to 202-9 to generate signal data y′(k) (k=0, 1, . . . 71) for output to the radix-9 butterfly processing unit 203-1 to 203-8.

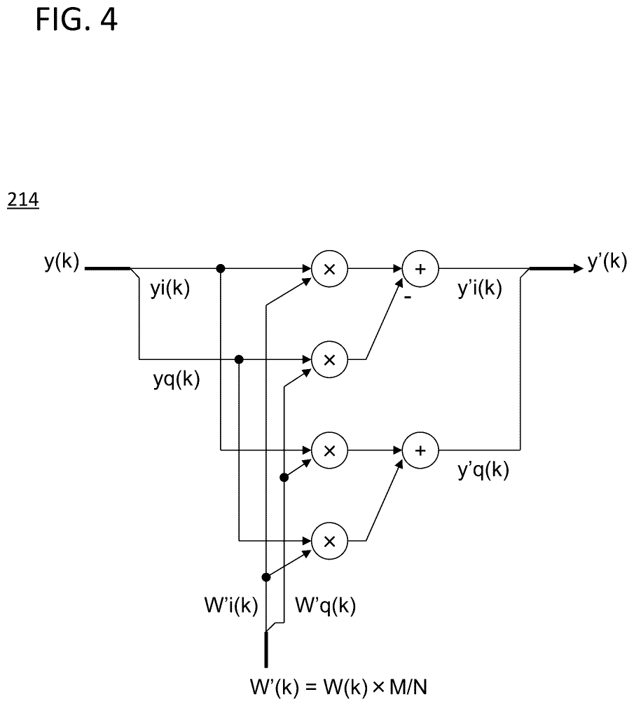

FIG. 4 is a schematic diagram illustrating the complex multiplication circuit 214 illustrated in FIG. 3. The complex multiplication circuit 214 multiplies the input signal data y (k) by the converted twiddle operation coefficient W′(k) and outputs the result of the multiplication as the signal data y′(k), where y (k), y′(k), and W′(k) are all complex numbers and given as follows.

Assuming that

$$y ( k ) = yi ( k ) + jyq ( k ) \qquad ( 1 )$$

$${W}^{′} ( k ) = {W}^{′} i ( k ) + {jW}^{′} q ( k ) \qquad ( 2 )$$

$${y}^{′} ( k ) = {y}^{′} i ( k ) + {jy}^{′} q ( k ) \qquad ( 3 )$$

$$then ,$$

$${y}^{′} i ( k ) = yi ( k ) \times {W}^{′} i ( k ) - yq ( k ) \times {W}^{′} q ( k ) \qquad ( 4 )$$

$${y}^{′} q ( k ) = yi ( k ) \times {W}^{′} q ( k ) - yq ( k ) \times {W}^{′} i ( k ) \qquad ( 5 )$$

In the present embodiment, during IFFT processing where the number of points N is a positive integer other than a power of 2 (in the present embodiment, N=72), the computing 1/N (1/N scaling) in the IFFT processing is implemented by the converted twiddle factor operation processing unit 204 and the 1/M operation unit 205 (in the present embodiment, M=64). Specifically, in the converted twiddle factor operation processing unit 204, in addition to the original twiddle factor operation coefficient W(k) (W(k)=exp(2πjk/N), j×j=−1) for the IFFT processing, multiplication by M/N causes the signal data to be amplified by a factor of M/N. Next, in the 1/M operation unit 205, the signal data is divided by M. As a result, the signal data is multiplied by M/N×1/M=1/N, that is, 1/N multiplication (1/N scaling) for the IFFT processing is performed.

Since M is a power of 2, the 1/M multiplication processing in the 1/M operation unit 205 may be implemented using a shift operation or the like. Specifically, in case where M is the n-th power of 2, i.e., M=2\hat{ }n, where n is an integer and the signal data is represented in a fixed point format, the 1/M operation may be implemented by a right shift circuit that performs a n-bit right shift operation on the signal data. Alternatively, in case where M is the n-th power of 2 and the signal data is represented in a floating-point format (composed of a sign bit (MSB), followed by exponent bits (exponent part) and mantissa bits), the 1/M operation may be implemented by a subtracter that subtracts n from an exponent part of the signal data. In the converted twiddle factor operation processing unit 204, the converted twiddle factor operation coefficient W′(k) (W′(k)=W(k)×M/N, W(k)=exp(2πjk/N), j×j=−1) is a constant value independent of signal data values and can therefore be computed and stored in a memory in advance. Therefore, no new multiplication circuit is required to compute the converted twiddle factor operation coefficient W′(k) itself. The multiplication circuit that implements the twiddle factor operation processing originally provided in the IFFT circuit can perform the multiplication processing between the signal data y (k) and the converted twiddle operation coefficient W′(k). As a result, compared with the IFFT circuit requiring a division circuit by N or a multiplication circuit for 1/N processing, the present embodiment enables the realization of an IFFT circuit with a smaller circuit scale and lower power consumption. Though the above describes the example where N=72 and M=64, the disclosure can be applied to any positive integer N other than a power of 2, and any positive integer M that is a power of 2 (M=2\hat{ }n, where n is an integer).

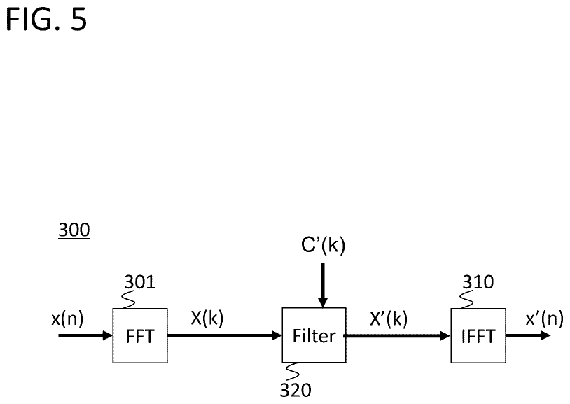

FIG. 5 is a diagram illustrating an example configuration of a digital filter circuit 300 of one of embodiments of the present disclosure. Referring to FIG. 5, the digital filter circuit 300 includes an FFT circuit 301, a converted filter processing circuit 320, and an IFFT circuit 310, and performs digital filter processing using frequency-domain equalization technology. In the present embodiment, the number of points N for the FFT circuit 301 and the IFFT circuit 310 is set to 72.

The FFT circuit 301 transforms 72 pieces of time-domain signal data x(n) (n=0, 1, . . . , 71) in a time-domain into 72 pieces of frequency-domain signal data X(k) (k=0, 1, . . . , 71). Next, the converted filter processing circuit 320 multiplies the 72 pieces of the frequency-domain signal data X(k) (k=0, 1, . . . , 71) by 72 converted filter coefficients C′(k) (C′(k)=C(k)×M/N), and outputs multiplication results as 72 pieces of signal data X′(k)=X(k)× C′(k) (k=0, 1, . . . , 71) in the frequency-domain, where N is the number of FFT/IFFT points, and M is a power of 2. The converted filter coefficient C′(k) is a coefficient obtained by multiplying the filter coefficient C(k) for frequency-domain equalization, by M/N. In the present embodiment, N=72, M=64, and M/N=64/72.

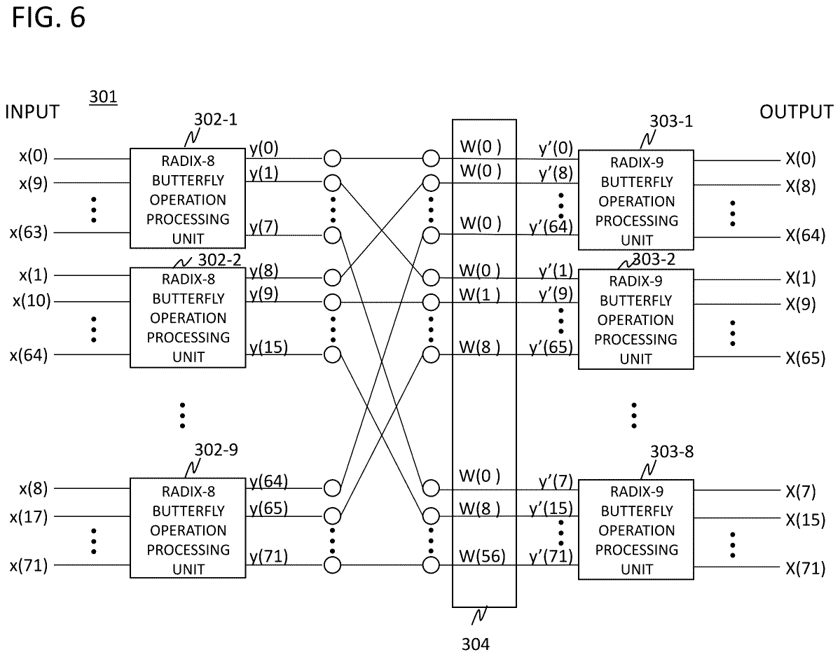

FIG. 6 is a diagram illustrating an example configuration of the FFT circuit 301. FIG. 6 illustrates a 72-point FFT circuit 301 decomposed, using the Cooley-Tukey algorithm, into two stages: a radix-8 butterfly processing stage and a radix-9 butterfly processing stage. The FFT circuit 301 includes 9 radix-8 butterfly operation processing units (circuits) 302-1 to 302-9 and 8 radix-9 butterfly operation processing units (circuits) 303-1 to 303-8, a twiddle factor operation processing unit (circuit) 304 that multiplies twiddle operation coefficients W(k) (W(k)=exp(−2πjk/N), j×j=−1) to corresponding data (In FIG. 6, twiddle operation the coefficients include (W(0),W(0), . . . , W(0)), (W(0),W(1), . . . , W(8)), . . . , (W(0), W(8), . . . , W(56)).). In the FFT circuit 301, 72 input time-domain signal data x(n) (n=0, 1, . . . , 71) are subjected to FFT processing to be transformed into frequency-domain signal data X(k) (k=0, 1, . . . , 71). It is noted that in FIG. 6, a part of data flow is omitted.

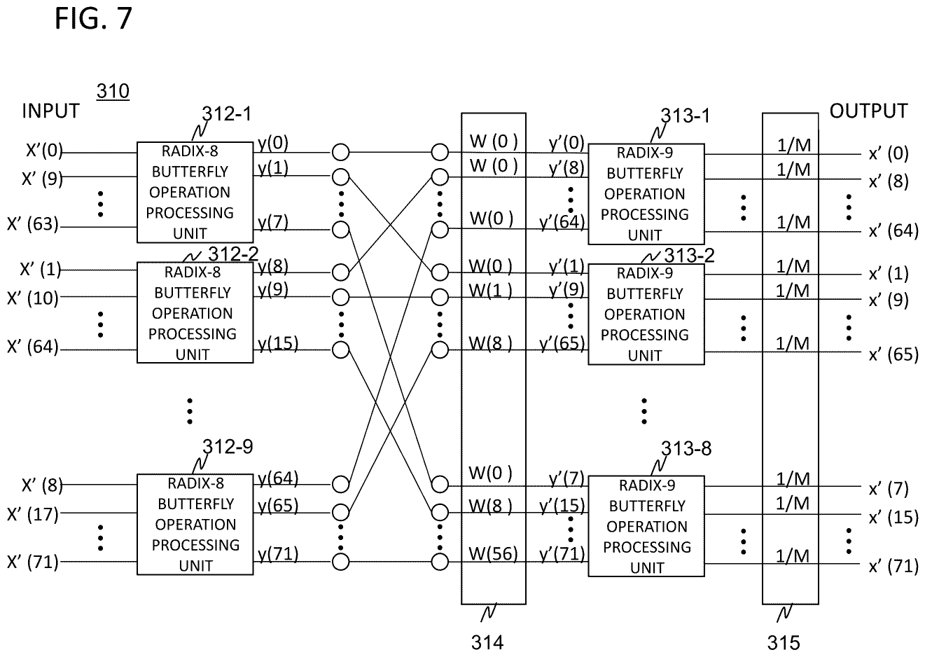

FIG. 7 is a diagram illustrating an example configuration of the IFFT circuit 310. FIG. 7 illustrates a 72-point IFFT circuit 310 decomposed, using the Cooley-Tukey algorithm, into two stages: a radix-8 butterfly operation and a radix-9 butterfly operation. The IFFT circuit 310 includes: 9 radix-8 butterfly operation processing units (circuits) 312-1 to 312-9 and 8 radix-9 butterfly operation processing units (circuits) 313-1 to 313-8, a twiddle operation processing unit (circuit) 314 configured to multiply the twiddle factor operation coefficients W(k) (W(k)=exp(2πjk/N), j×j=−1), (in FIG. 7, the twiddle operation coefficients are (W(0), W(0), . . . , W(0)), (W(0), W(1), . . . , W(8)), . . . , (W(0), W(8), . . . , W(56)).), and a 1/M operation unit (circuit) 315 configured to perform 1/M operation, where M is a power of 2. In the present embodiment, M=64. Since M is a power of 2, the 1/M operation unit 315 can be implemented using a circuit with small scale and low power consumption, such as a right shift circuit. In the IFFT circuit 310, 72 pieces of frequency-domain signal data X′(k) (k=0, 1, . . . , 71) are subjected to IFFT processing to be transformed into time-domain signal data x′(n) (n=0, 1, . . . , 71). It is noted that a part of data flow is omitted only for the sake of drawing convenience in FIG. 7.

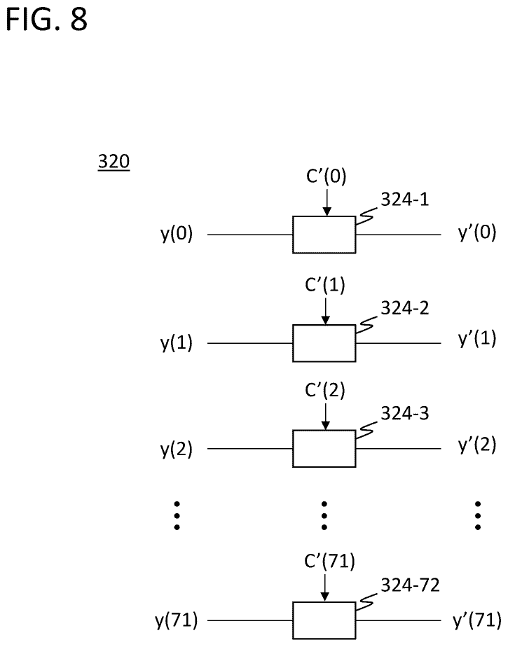

FIG. 8 is a diagram illustrating an example configuration of the converted filter processing circuit 320 of FIG. 5. Referring to FIG. 8, the converted filter processing circuit 320 includes 72 complex multiplication circuits 324-1 to 324-72, corresponding to the number of points of 72 point FFT/IFFT. Each of the 72 pieces of frequency-domain signal data X(k) (k=0, 1, . . . , 71) output from the FFT circuit 301, is multiplied by each of the 72 converted filter coefficients C′(k) (C′(k)=C(k)×M/N) to output 72 pieces of signal data X′(k)=X(k)× C′(k) (k=0, 1, . . . , 71) to the IFFT circuit 310.

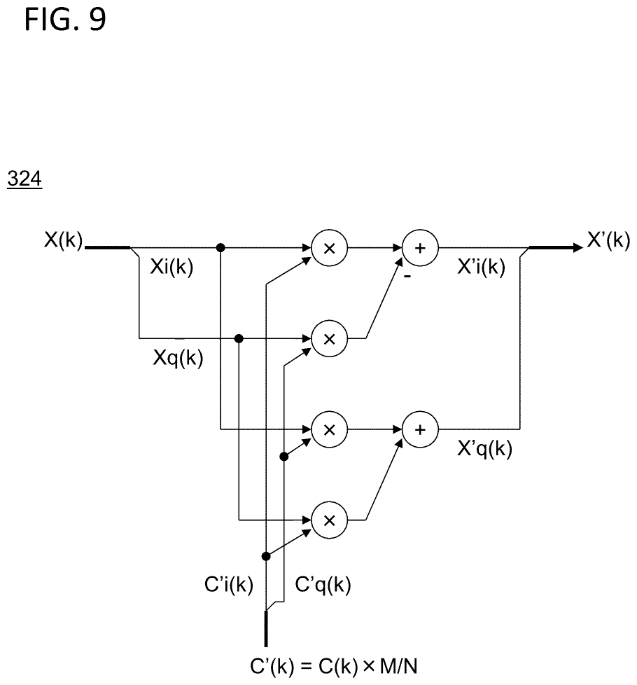

FIG. 9 is a schematic diagram illustrating the example configuration of the complex multiplication circuit 324. The complex multiplication circuit 324 multiplies the input signal data X(k) by the converted filter coefficient C′(k) to output a multiplication result as signal data X′(k), where X(k), X′(k) and C′(k) are all complex numbers given as follows.

Assuming that

$$X ( k ) = Xi ( k ) + jXq ( k ) \qquad ( 6 )$$

$${C}^{′} ( k ) = {C}^{′} i ( k ) + {jC}^{′} q ( k ) \qquad ( 7 )$$

$${X}^{′} ( k ) = {X}^{′} i ( k ) + {jX}^{′} q ( k ) , \qquad ( 8 )$$

$$then$$

$${X}^{′} i ( k ) = Xi ( k ) \times {C}^{′} i ( k ) - Xq ( k ) \times {C}^{′} q ( k ) \qquad ( 9 )$$

$${X}^{′} q ( k ) = Xi ( k ) \times {C}^{′} q ( k ) - Xq ( k ) \times {C}^{′} i ( k ) \qquad ( 10 )$$

As described above, in the present embodiment, when the number of points N in the digital filter circuit 300 is an integer other than a power of 2 in the IFFT circuit (where N=72), computing 1/N (1/N scaling) in the IFFT processing is implemented by the converted filter processing circuit 320 and the 1/M operation unit 315 in the IFFT circuit 310 (where M=64). Specifically, in the converted filter processing circuit 320, the signal data is multiplied by M/N, in addition to the filter coefficient C(k) for frequency-domain equalization. That is, the signal data is multiplied by (M/N)×C(k). Next, in the 1/M operation unit 315 in the IFFT circuit 310, the signal data is divided by M. As a result, the signal data is multiplied by (M/N)×1/M=1/N, thereby performing 1/N multiplication (1/N scaling) for the IFFT processing. Since M is a power of 2, the 1/M multiplication processing in the 1/M operation unit 315 can be implemented using a shift operation or the like. Specifically, when M is 64 (26) (or M=2\hat{ }n, where n is a positive integer) and the signal data is represented in fixed-point format, the 1/M operation can be achieved by performing a 6-bit right shift operation on the signal data. Alternatively, when the signal data is represented in a floating-point format, the 1/M (=2⁶) operation can be implemented by subtracting 6 from an exponent part of the signal data.

In the converted filter processing circuit 320, the converted filter coefficient C′(k) (C′(k)=C(k)×M/N) is a constant value that does not change during the filter processing, regardless of signal data values. Therefore, the converted filter coefficient can be computed in advance, for example, during circuit design or before executing the filter processing. Therefore, no new multiplication circuit is required to compute the converted filter coefficient C′(k) itself. The same multiplication circuit to implement the frequency-domain equalization can also perform the multiplication operation between the signal data X(k) and the converted filter coefficient C′(k). As a result, compared to the IFFT circuit requiring division circuits by M or multiplication circuits for 1/M processing, the present embodiment enables the realization of the IFFT circuit with smaller circuit scale and lower power consumption. This also enables reduction of a circuit size and a power consumption of the digital filter circuit that achieves frequency-domain equalization, including the IFFT circuit.

In the above, a case where N=72 and M=64 is described, N may be any positive integer other than a power of 2, and M may be any positive integer that is a power of 2.

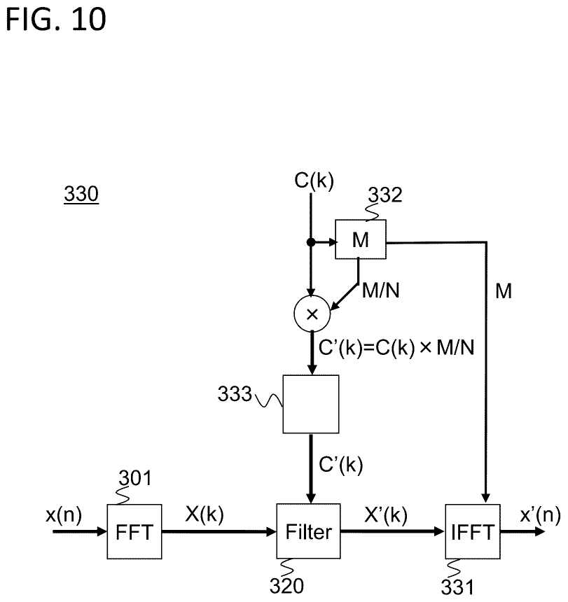

FIG. 10 is a diagram illustrating another example configuration of the digital filter circuit 330. Referring to FIG. 10, the digital filter circuit 330 includes an FFT circuit 301, a converted filter processing circuit 320, an IFFT circuit 331, an M-selection circuit 332, and a coefficient table circuit 333, and performs digital filter processing using frequency-domain equalization technology. In the present embodiment, the FFT circuit 301 and the converted filter processing circuit 320 have the same configuration described with reference to FIG. 5 to FIG. 8. The number of points N for the FFT circuit 301 and the IFFT circuit 331 are 72.

The M-selection circuit 332 is configured to select a value of M which is a power of 2, by taking into consideration a value of the filter coefficient C(k) (k=0, 1, . . . , N−1) for frequency-domain equalization. In selecting the value of M=2\hat{ }n (n-th power of 2), the M-selection circuit 332 selects a value of n. The M-selection circuit 332 computes the converted filter coefficient C′(k) (k=0, 1, . . . , N−1) by multiplying the filter coefficient C(k) by M/N.

$${C}^{′} ( k ) = C ( k ) \times M / N \qquad ( 11 )$$

The M-selection circuit 332 may be configured to select M, a power of 2 such that the converted filter coefficient C′(k) is set to a maximum possible value in a predetermined configurable range of C′(k) (k=0, 1, . . . , N−1).

When the value of the filter coefficient C(k) is small, the M-selection circuit 332 may select M (=2\hat{ }n) having a large value, thus the value of C′(k) being large. On the other hand, when the value of C(k) is large, the M-selection circuit 332 may M (=2\hat{ }n) having a small value, thus the value of C′(k) being small.

More specifically, the M-selection circuit 332 is configured to appropriately select M by taking int account values of the filter coefficients C(k) (k=0, 1, . . . , N−1) to keep the values of the converted filter coefficients C′(k) within a predetermined fixed range, regardless of the value of the filter coefficients C(k).

The M-selection circuit 332 outputs a selected value of M, a power of 2, to the IFFT circuit 331. Based on the selected value of M, a power of 2, the M-selection circuit 332 outputs M/N (in the present embodiment, N=72, M=128, M/N=128/72) to the coefficient table circuit 333.

The coefficient table circuit 333 is configured to store and hold 72 converted filter coefficients C′(k)=C(k)×M/N (k=0, 1, . . . , 71), each of which is obtained by multiplying C(k) by the M/N output by the M-selection circuit 332.

The digital filter circuit 330 may receive the 72 filter coefficients C(k) (k=0, . . . ,71) one by one, compute corresponding converted filter coefficients C′(k) one by one for storge in the coefficient table circuit 333. The coefficient table circuit 333 may output the 72 stored converted filter coefficients C′(k) (k=0, 1, . . . , 61) to converted filter processing circuit 320 simultaneously.

In the present embodiment, as with the digital filter 300 described with reference to FIG. 5, the converted filter processing circuit 320 multiplies each of the frequency-domain signal data X(k) (k=0, 1, . . . , 71) output by the FFT circuit 301 by the converted filter coefficient C′(k) (C′(k)=C(k)×M/N)

The converted filter processing circuit 320 outputs a result of multiplying the signal data X(k) by the converted filter coefficient C′(k) as the signal data X′(k) (k=0, 1, . . . 71) to the IFFT circuit 331.

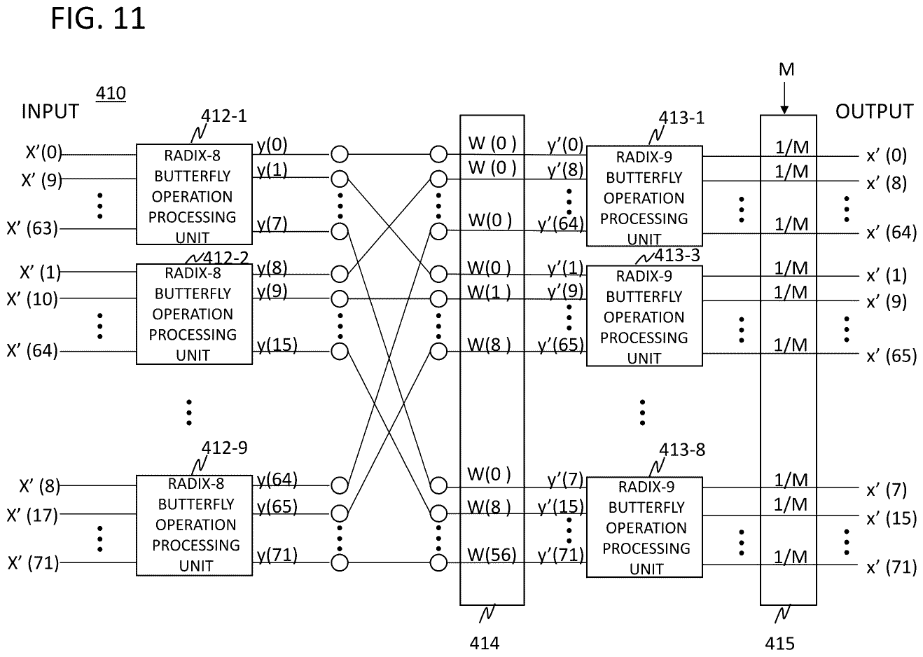

FIG. 11 is a diagram illustrating one configuration example of the IFFT circuit 331 of the digital filter circuit 330 in FIG. 10. FIG. 11 illustrates a 72-point IFFT circuit 410 decomposed into two stages using the Cooley-Tukey algorithm: a radix-8 butterfly operation and a radix-9 butterfly operation. The IFFT circuit 410 includes 9 radix-8 butterfly operation processing units (circuits) 412-1 to 412-9 and 8 radix-9 butterfly operation processing units (circuits) 413-1 to 413-8, a twiddle factor operation processing unit (circuit) 414 configured to multiply twiddle factor operation coefficients W(k) (W(k)=exp(2πjk/N), j×j=−1) (FIG. 11 illustrates that the twiddle operation coefficients are (W(0), W(0), . . . , W(0)), (W(0), W(1), . . . , W(8)), . . . , (W(0), W(8), . . . , W(56)), and a 1/M operation unit 415 configured to perform a 1/M operation.

In the present embodiment, the butterfly operation processing units (circuits) 412 and 413, and the twiddle factor operation processing unit 414 have the same configuration as the IFFT circuit 310 described with reference to FIG. 7. The 1/M operation unit 415 performs a 1/M operation on the signal data output by the butterfly operation processing units 413-1 to 413-8, based on the value of M output by the M-selection circuit 332 (FIG. 10). Here, M is a power of 2. In the present example, M=128. Since M is a power of 2, the 1/M operation unit 415 can be implemented with a small circuit scale and a low power consumption, such as a right shift circuit. In the IFFT circuit 410 illustrated in FIG. 11, 72 pieces of frequency-domain signal data X′(k) (k=0, 1, . . . , 71) are subjected to IFFT processing to be transformed into time-domain signal data x′(n) (n=0, 1, . . . , 71). It is noted in FIG. 11, a part of data flow is omitted.

As described above, in the present embodiment, when the number of points N in the digital filter circuit 330 is other than a power of 2 in the IFFT circuit (in the present embodiment, N=72), the processing to compute the 1/N required for IFFT processing is performed by both the converted filter processing circuit 320 and the 1/M operation unit 415 provided in the IFFT circuit 331 (In the present embodiment, M=128).

Specifically, in the converted filter processing circuit 320, in addition to the filter coefficient C(k) for frequency-domain equalization, the signal data is multiplied by M/N, thereby the signal data multiplied by a factor of M/N. The 1/M operation unit 315 in the IFFT circuit 310 multiplies the signal data by 1/M. As a result, the signal data is multiplied by M/N×1/M=1/N, thereby performing the 1/N multiplication (scaling) required for the IFFT processing. Since M is a power of 2 here, the 1/M multiplication processing in the 1/M operation unit 415 can be implemented using a shift operation or the like. When M is 2\hat{ }n (M=2\hat{ }n, where n is a positive integer) (M=128=27) and the signal data is represented in a fixed-point format, the 1/M multiplication processing can be achieved by performing a 7-bit right shift operation on the signal data. Alternatively, when the signal data is represented in a floating-point format, the 1/M multiplication processing can be achieved by subtracting 7 from an exponent part of the signal data.

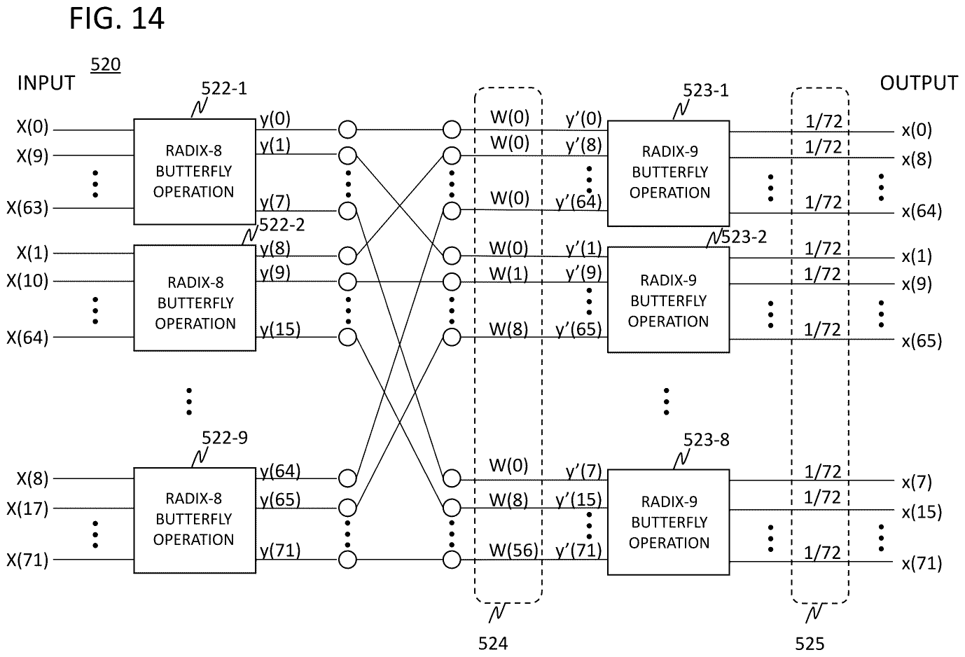

In the converted filter processing circuit 320, each converted filter coefficient C′(k) (C′(k)=C(k)×M/N) is a constant value that does not change during the filter processing, regardless of a value of signal data. Therefore, N converted filter coefficient C′(k) (k=0, 1, . . . , N−1) are allowed to be computed in advance, one by one, before executing the filter processing and stored in the coefficient table circuit 333. Therefore, only one additional multiplication circuit (complex multiplication circuit) is needed to compute N converted filter coefficient C′(k) (k=0, 1, . . . , N−1). The multiplication operation between the signal data X(k) and the converted filter coefficient C′(k) can be performed using the multiplication circuits (complex multiplication circuits) originally provided to implement frequency-domain equalization. As a result, compared with the IFFT circuit with a divide-by N circuit or a 1/N multiplication circuit for 1/N scaling, as described with reference to FIG. 14, the present disclosure can provide the IFFT circuit with a smaller circuit size and a lower power consumption. According to the present disclosure, a circuit size and a power consumption of a digital filter circuit that includes the IFFT circuit and performs frequency-domain equalization can be reduced.

The M-selection circuit 332 may be configured to appropriately select M by taking into consideration a value of the filter coefficient C(k), thereby keeping the value of the converted filter coefficient C′(k) within a preset range. As a result, a signal amplitude of the input signal data X′(k)=X(k)× C′(k) to the IFFT circuit 331 may be adjusted to an appropriate range. This allows for a reduction in computational error within the IFFT circuit 331, even when the filter coefficient C(k) has a small value. Since there is no need to increase a computational precision of the IFFT circuit 331 in preparation for a case where the value of C(k) is small, the circuit size and power consumption of the IFFT circuit 331 can be reduced.

In the above, the case where N=72 and M=128 (=2⁷) is described, N may be any positive integer that is other than a power of 2, and M may be to any positive integer that is a power of 2 as long as M meets the constraint for M described with regard to Equation (11).

In an N-point discrete Fourier transform (DFT), the number of complex multiplications is N squared. In contrast, in an N point FFT where Nis a power of 2, the number of complex multiplications is (N/2) log₂(N), and the number of complex additions is N log₂(N). The following describes examples of the present disclosure applied to DFT. N-point DFT may be given as follows.

$$X ( k ) = {\sum }_{n = 0}^{N - 1} x ( n ) {W}_{N}^{kn} , k = 0 , 1 , … , N - 1 \qquad ( 12 )$$

$${W}_{N} = exp ( - j \frac{2 π}{N} ) \qquad ( 13 )$$

where W_{N} is a twiddle factor with a resolution of N points, where a phase rotates clockwise

$$\frac{2 π}{N}$$

radians for each increment of k.

The N-points inverse discrete Fourier transform (IDFT) may be given as follows.

$$x ( n ) = \frac{1}{N} {\sum }_{n = 0}^{N - 1} X ( k ) {W}_{N}^{- kn} , n = 0 , 1 , … , N - 1 \qquad ( 14 )$$

The following describes a 3-point DFT for N=3 as the simplest example where N is a positive integer other than a power of 2. When applying the 3-point DFT to (x(0), x(1), x(2)), a result (X(0), X(1), X(2)) may be given, from Equation (12), as the following Equation (15).

$$( \begin{matrix}X ( 0 ) \\ X ( 1 ) \\ X ( 2 )\end{matrix} ) = ( \begin{matrix}{W}_{3}^{0} & {W}_{3}^{0} & {W}_{3}^{0} \\ {W}_{3}^{0} & {W}_{3}^{1} & {W}_{3}^{2} \\ {W}_{3}^{0} & {W}_{3}^{2} & {W}_{3}^{4}\end{matrix} ) ( \begin{matrix}x ( 0 ) \\ x ( 1 ) \\ x ( 2 )\end{matrix} ) = ( \begin{matrix}1 & 1 & 1 \\ 1 & {W}_{3}^{1} & {W}_{3}^{2} \\ 1 & {W}_{3}^{2} & {W}_{3}^{1}\end{matrix} ) ( \begin{matrix}x ( 0 ) \\ x ( 1 ) \\ x ( 2 )\end{matrix} ) \qquad ( 15 )$$

The result (x(0), x(1), x(2)) obtained by applying a 3-point IDFT on (X(0), X(1), X(2)), may be given, from Equation (14), as the following Equation (16).

$$( \begin{matrix}x ( 0 ) \\ x ( 1 ) \\ x ( 2 )\end{matrix} ) = \frac{1}{3} ( \begin{matrix}{W}_{3}^{0} & {W}_{3}^{0} & {W}_{3}^{0} \\ {W}_{3}^{0} & {W}_{3}^{- 1} & {W}_{3}^{- 2} \\ {W}_{3}^{0} & {W}_{3}^{- 2} & {W}_{3}^{- 4}\end{matrix} ) ( \begin{matrix}X ( 0 ) \\ X ( 1 ) \\ X ( 2 )\end{matrix} ) \qquad ( 16 )$$

Substituting Equation (15) into (X(0), X(1), X(2)) in Equation (16), we have the following Equation (17).

$$( \begin{matrix}x ( 0 ) \\ x ( 1 ) \\ x ( 2 )\end{matrix} ) = \frac{1}{3} ( \begin{matrix}1 & 1 & 1 \\ 1 & {W}_{3}^{- 1} & {W}_{3}^{- 2} \\ 1 & {W}_{3}^{- 2} & {W}_{3}^{- 4}\end{matrix} ) ( \begin{matrix}1 & 1 & 1 \\ 1 & {W}_{3}^{1} & {W}_{3}^{2} \\ 1 & {W}_{3}^{2} & {W}_{3}^{1}\end{matrix} ) ( \begin{matrix}x ( 0 ) \\ x ( 1 ) \\ x ( 2 )\end{matrix} ) = \frac{1}{3} ( \begin{matrix}1 + 1 + 1 & 1 + {W}_{3}^{1} + {W}_{3}^{2} & 1 + {W}_{3}^{2} + {W}_{3}^{1} \\ 1 + {W}_{3}^{- 1} + {W}_{3}^{- 2} & 1 + 1 + 1 & 1 + {W}_{3}^{1} + {W}_{3}^{- 1} \\ 1 + {W}_{3}^{- 2} + {W}_{3}^{- 4} & 1 + {W}_{3}^{- 1} + {W}_{3}^{- 2} & 1 + 1 + 1\end{matrix} ) ( \begin{matrix}x ( 0 ) \\ x ( 1 ) \\ x ( 2 )\end{matrix} ) \qquad ( 17 )$$

Using the following relation regarding the twiddle factor W₃,

$$1 + {W}_{3}^{1} + {W}_{3}^{2} = 1 + {W}_{3}^{- 1} + {W}_{3}^{- 2} == 1 + {W}_{3}^{1} + {W}_{3}^{- 1} = 1 + {W}_{3}^{- 2} + {W}_{3}^{- 4} = 0 ,$$

Equation (17) is given as follows.

$$= \frac{1}{3} ( \begin{matrix}3 & 0 & 0 \\ 0 & 3 & 0 \\ 0 & 0 & 3\end{matrix} ) ( \begin{matrix}x ( 0 ) \\ x ( 1 ) \\ x ( 2 )\end{matrix} ) = ( \begin{matrix}1 & 0 & 0 \\ 0 & 1 & 0 \\ 0 & 0 & 1\end{matrix} ) ( \begin{matrix}x ( 0 ) \\ x ( 1 ) \\ x ( 2 )\end{matrix} ) = ( \begin{matrix}x ( 0 ) \\ x ( 1 ) \\ x ( 2 )\end{matrix} ) \qquad ( 18 )$$

From Equation (18), it is confirmed that

$$( x ( 1 ) , x ( 2 ) , … , x ( N ) ) = IDFT ( DFT [ ( x ( 1 ) , x ( 2 ) , … , x ( N ) ) ] ) \qquad ( 19 )$$

holds true due to the operation of the scale factor (1/N) in the IDFT of Equation (14).

When N=2ⁿ, since 1/N is 2⁽⁻ⁿ⁾, each coefficient in the binary representation can be obtained by performing an n-bit arithmetic shift. In case of N=3, setting M as 2\hat{ }n (n: integer), 1/N=(1/M)×(M/N), and multiplying the twiddle factor W_{N}^{k} (k=0, 2, 2) by (M/3) and then multiplying by (1/M) as indicated in the following Equation (20). It is noted that in Equation (20), in M=2ⁿ; n may include 0 or a negative integer if there are no issues with computation precision in the multiplication of the twiddle factor W_{N}^{k}.

$$( \begin{matrix}x ( 0 ) \\ x ( 1 ) \\ x ( 2 )\end{matrix} ) = ( \frac{1}{M} ) \times ( \frac{M}{3} ) ( \begin{matrix}1 & 1 & 1 \\ 1 & {W}_{3}^{- 1} & {W}_{3}^{- 2} \\ 1 & {W}_{3}^{- 2} & {W}_{3}^{- 4}\end{matrix} ) ( \begin{matrix}X ( 0 ) \\ X ( 1 ) \\ X ( 2 )\end{matrix} ) = \frac{1}{M} ( \begin{matrix}M / 3 & M / 3 & M / 3 \\ M / 3 & ( M / 3 ) {W}_{3}^{2} & ( M / 3 ) {W}_{3}^{1} \\ M / 3 & ( M / 3 ) {W}_{3}^{1} & ( M / 3 ) {W}_{3}^{2}\end{matrix} ) ( \begin{matrix}X ( 0 ) \\ X ( 1 ) \\ X ( 2 )\end{matrix} ) \qquad ( 20 )$$

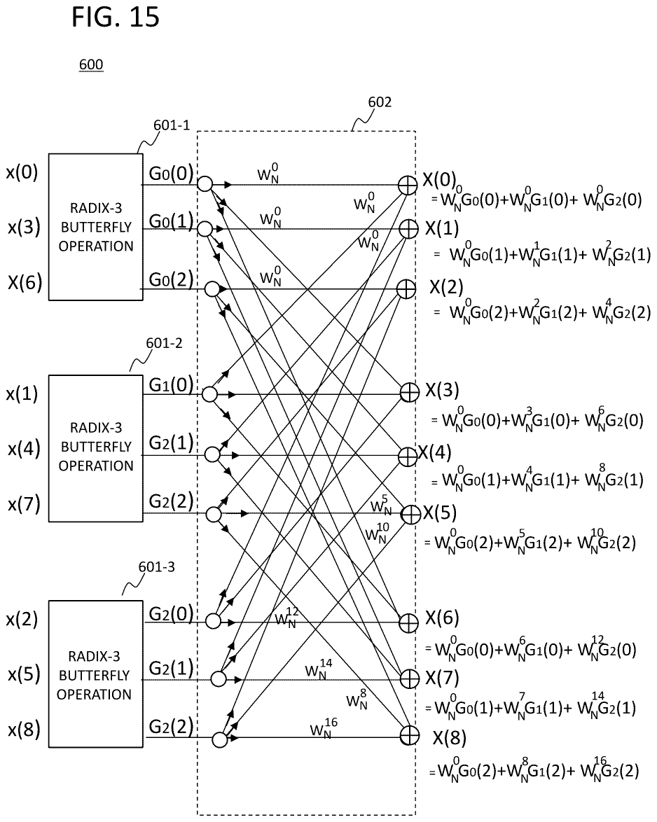

FIG. 15 illustrates a signal flow 600 of a DFT with N=9 as a simple example where the number of points N is a positive integer other than a power of 2. The following outlines the DFT in FIG. 15, defined by the following Equation (21), a simple example of a mixed radix number, where the number of points N=p1×q1=3×3 (p1=3, q1=3).

$$X ( k ) = {\sum }_{l = 0}^{{p}_{1} - 1} {W}_{N}^{lk} {\sum }_{r = 0}^{{q}_{1} - 1} x ( {p}_{1} r + l ) {W}_{N}^{{p}_{1} rk} , k = 0 , 1 , … , N \qquad ( 21 )$$

$$where$$

$${W}_{N} = exp ( - 2 π j / N ) \qquad ( 22 )$$

The inner loop in Equation (21) can be expressed as a q1 point DFT, as defined by the following Equation (23).

$${G}_{l} ( k ) = {\sum }_{r = 0}^{{q}_{1} - 1} x ( {p}_{1} r + l ) {W}_{N}^{{p}_{1} rk} \qquad ( 23 )$$

The inner loop of Equation (21) may be implemented in FIG. 15 by 3 radix-3 butterfly operations (operation processing units) 601-1 to 601-3 (first-stage butterfly operation). More specifically, the radix-3 butterfly operation 601-1 in FIG. 15 receives (x(0), x(3), x(6)) as input and outputs (G₀(0), G₀(1), G₀(2)), corresponding to l=0 and k=0, 1, 2 in Equation (23). The radix-3 butterfly operation 601-2 in FIG. 15 takes (x(1), x(4), x(7)) as input and outputs (G₁(0), G₁(1), G₁(2)), corresponding to l=1 and k=0, 1, 2 in Equation (23).

The radix-3 butterfly operation 601-3 in FIG. 15 takes (x(2), x(5), x(8)) as input and outputs (G₂(0), G₂(1), G₂(2)), corresponding to l=2 and k=0, 1, 2 in Equation (23).

The butterfly operation (processing unit) 602 in the outer loop of Equation (21) can be expressed as a pl-points DFT at point p1.

$$X ( k ) = {\sum }_{l = 0}^{{p}_{1} - 1} {W}_{N}^{lk} {G}_{l} ( k ) , k = 0 , 1 , … , N \qquad ( 24 )$$

In FIG. 15, the twiddle factors in the butterfly operation unit 602 corresponds to W_{N}^{1k} in Equation (24). In FIG. 15, for the sake of drawing, a part of twiddle factors W_{N}^{1k} are shown and twiddle factors W_{N}^{1k} are explicitly given within each expression for X(k) (k=0, . . . , N−1).

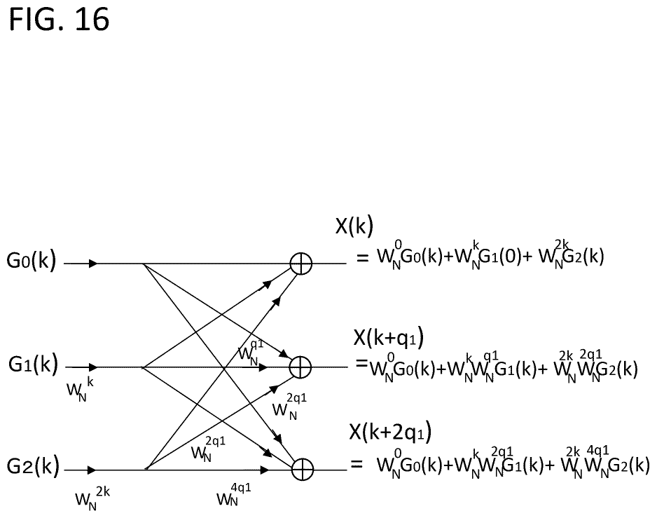

The butterfly operation processing unit 602 in FIG. 15 may be configured, as a radix-3 butterfly operation, for example, as illustrated in FIG. 16, to achieve efficiency.

$$X ( k ) = {G}_{0} ( k ) + {W}_{N}^{k} {G}_{1} ( k ) + {W}_{N}^{2 k} {G}_{2} ( k ) \qquad ( 25 )$$

$$X ( k + q 1 ) = {G}_{0} ( k ) + {W}_{N}^{k} {W}_{N}^{q 1} {G}_{1} ( k ) + {W}_{N}^{2 k} {W}_{N}^{2 q 1} {G}_{2} ( k ) \qquad ( 26 )$$

$$X ( k + 2 q 1 ) = {G}_{0} ( k ) + {W}_{N}^{k} {W}_{N}^{2 q 1} {G}_{1} ( k ) + {W}_{N}^{2 k} {W}_{N}^{4 q 1} {G}_{2} ( k ) \qquad ( 27 )$$

$$where$$

$${W}_{n}^{q 1} = exp [ - j ( \frac{2 π}{3} ) ] \qquad ( 28 )$$

$$By setting$$

$${W}_{N} = exp [ j ( \frac{2 π}{N} ) ] \qquad ( 29 )$$

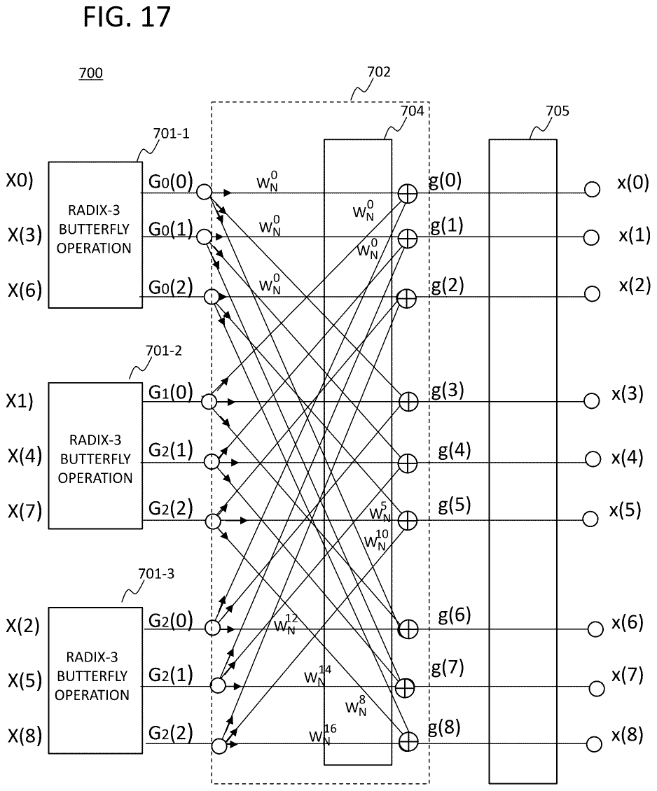

in FIG. 15, the signal flow of the N-points IDFT where N=9, is as illustrated in FIG. 17.

In FIG. 17, a butterfly operation (processing unit) 702 provided subsequent to the three sets of radix-3 butterfly operations performs the same butterfly operation as butterfly operation 602 in FIG. 15. It is noted that for the sake of drawing convenience, the expressions for the butterfly operation results (twiddle factor operation processing results) (g(0), g(1), g(2), . . . , g(8)) are omitted.

The converted twiddle factor operation (processing unit) 704 multiplies (M/N)=(2ⁿ/9) by each rotor W_{N}^{1k} (1=0, . . . , p1−1, k=0, 1, 2) in Equation (24). Therefore, (g(0), g(1), g(2), . . . , g(8)) in FIG. 17 are obtained by multiplying (X(0), X(1), X(2), . . . , X(8)) which are the butterfly operation result in FIG. 15, by (M/N) (=2ⁿ/9).

The 1/M operation (processing unit) 705 multiplies (g(0), g(1), g(2), . . . , g(8)) by (1/M) (=2⁻ⁿ) to output (x(0), x(1), x(2), . . . , x(8)).

The butterfly operation 702 in FIG. 17 may also be configured as illustrated in FIG. 16.

The above embodiment is also applicable to the following variations of DFT (FFT). For example, in the DFT (FFT) side, the calculation result is multiplied by (1/N) before output, while in the IDFT (IFFT), the (1/N) calculation (scale factor calculation) is not performed (as illustrated in the following Equations (30), and (31)) or where the DFT (FFT) outputs the result multiplied by (1/\sqrt{N}) and the IDFT (IFFT) outputs the result multiplied by (1/\sqrt{N}) (as illustrated in Equations (31) and (32) below).

$$X ( k ) = ( \frac{1}{N} ) {\sum }_{n = 0}^{N - 1} x ( n ) {W}_{N}^{kn} = ( \frac{1}{M} ) {\sum }_{n = 0}^{N - 1} x ( n ) ( \frac{M}{N} ) {W}_{N}^{kn} , k = 0 , 1 , … , N - 1 \qquad ( 30 )$$

$$x ( n ) = {\sum }_{k = 0}^{N - 1} X ( k ) {W}_{N}^{- kn} , n = 0 , 1 , … , N - 1 \qquad ( 31 )$$

$$X ( k ) = ( \frac{1}{\sqrt{N}} ) {\sum }_{n = 0}^{N - 1} x ( n ) {W}_{N}^{kn} = ( \frac{1}{M} ) {\sum }_{n = 0}^{N - 1} x ( n ) ( \frac{M}{\sqrt{N}} ) {W}_{N}^{kn} , k = 0 , 1 , … , N - 1 \qquad ( 32 )$$

$$x ( n ) = ( \frac{1}{\sqrt{N}} ) {\sum }_{k = 0}^{N - 1} X ( k ) {W}_{N}^{- kn} = ( \frac{1}{M} ) {\sum }_{k = 0}^{N - 1} X ( k ) ( \frac{M}{\sqrt{N}} ) {W}_{N}^{- kn} , k = 0 , 1 , … , N - 1 \qquad ( 33 )$$

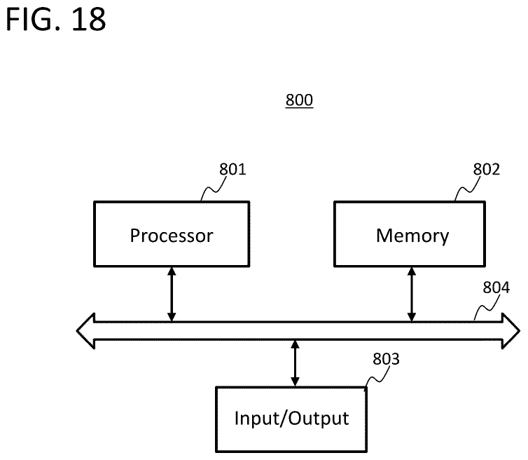

The embodiments described above may be implemented in a signal processing processor 800, in which a processor 801, such as a DSP (Digital Signal Processor), an operation of which is variably controlled by a program that is executable by the processor (DSP) 801 and stored in memory 802, as illustrated in FIG. 18. In FIG. 18, an I/O apparatus 803 connected to the processor 801 via a bus 804 is used for data input and output of computation results of signal data. A memory 802 may be configured to include any of the following: DRAM (Dynamic RAM (Random Access Memory)), ROM (Read-Only Memory), EEPROM (Electrically Erasable Programmable Read-Only Memory), SSD (Solid State Drive), HDD (Hard Disk Drive), or the like.

The radix-8 butterfly operation may be a radix-4×radix-2 butterfly operation, and the radix-9 butterfly operation may be a radix-3×radix-3 butterfly operation.
[Reference Literature 1] JPH08-137832A (pages 3-5, FIG. 25)
[Reference Literature 2] D. P. Kolba, “A Prime Factor FFT Algorithm Using High Speed Convolution”, IEEE Trans. on Acoustics, US, IEEE Signal Processing Society, August 1977, Vol. 29, No. 4, pp. 281-294

The disclosures of each of the Non-Patent Literature and Reference Literatures are hereby incorporated by reference into this document. Within the scope of the disclosure of the present application (including the claims), modifications, adjustments, and combinations of embodiments or examples based on the fundamental technical concept are possible. Furthermore, within the scope of the claims of the present disclosure, various combinations or selections of the disclosed elements (including each element of the appended claims, each element of the embodiments, each element of the drawings, etc.) are possible. That is, the present disclosure as a matter of course encompasses the entire disclosure, including the claims, and various modifications and alterations that would be obvious to one skilled in the art based on the technical concept.

What is claimed is:

1. A signal processing apparatus that performs an inverse fast Fourier transform (IFFT) on N pieces of input data, where Nis a positive integer greater than or equal to 3 and not a power of 2, the apparatus including:
a butterfly operation processing circuit configured to perform butterfly operation processing on the N pieces of input data;
a converted twiddle factor operation processing circuit configured to perform twiddle factor operation processing using converted twiddle factor coefficients, each obtained by multiplying each original twiddle factor coefficient for the IFFT by M/N; and
a 1/M operation circuit configured to perform 1/M operation processing on N pieces of output data, where M is a power of 2, to output result of the operation as N-points of output data of the IFFT.

2. The signal processing apparatus according to claim 1, wherein the 1/M operation circuit, in case where M is an n-th power of 2, is configured to
right-shift the output data n bits when the output data represented in a fixed-point format, or
subtract n from an exponent portion of the output data when the output data is represented in a floating-point format.

3. A signal processing apparatus including:
a fast Fourier transform apparatus configured to perform a fast Fourier transform (FFT) on every consecutive N pieces of input time-domain data where N is a positive integer, not a power of 2;
a converted filter operation apparatus configured to multiply each of N pieces of frequency-domain data generated by the fast Fourier transform apparatus by each converted filter coefficient obtained by multiplying each filter coefficient for frequency-domain equalization by (M/N), where M is a power of 2; and
an inverse fast Fourier transform apparatus that receives N pieces of frequency-domain data output from the converted filter processing apparatus to perform an inverse fast Fourier transform (IFFT) on the N pieces of frequency-domain data, wherein
the inverse fast Fourier transform apparatus includes:
a butterfly operation processing circuit configured to perform butterfly operation processing on the N pieces of frequency-domain data received;
a twiddle factor operation processing circuit configured to perform twiddle factor operation processing using twiddle factor coefficients for the IFFT; and
a 1/M operation circuit configured to perform 1/M operation processing on N pieces of output data to output the result of the operation.

4. The signal processing apparatus according to claim 3, including:
a selection circuit configured to select M, a power of 2, based on the filter coefficient for the frequency-domain equalization; and
a coefficient table configured to store N converted filter coefficients, each obtained by multiplying the filter coefficient for the frequency-domain equalization by (M/N), wherein the M is selected by the selection circuit,
wherein the 1/M operation circuit is configured to perform the 1/M operation, based on the M selected by the selection circuit.

5. The signal processing apparatus according to claim 4, wherein the selection circuit is configured to select M such that the converted filter coefficients are within a preset range.

6. The signal processing apparatus according to claim 3, wherein the converted filter operation apparatus includes
N multiplication circuits, each configured to multiply each of the N pieces of frequency-domain data generated by the fast Fourier transform apparatus by each of the N converted filter coefficients stored in the coefficient table.

7. The signal processing apparatus according to claim 3, wherein the converted filter operation apparatus includes
a multiplication circuit configured to multiply, one by one, the each filter coefficient for frequency-domain equalization by (M/N) to output the each converted filter coefficient to the coefficient table.

8. The signal processing apparatus according to claim 3, wherein the 1/M operation circuit, in case where M is an n-th power of 2, is configured to
right-shift the output data n bits when the output data represented in a fixed-point format, or
subtract n from an exponent portion of the output data when the output data is represented in a floating-point format.

9. A signal processing apparatus that performs at least one of:
N-point discrete Fourier transform (DFT) processing,
N-point inverse discrete Fourier transform (IDFT) processing,
N-point fast Fourier transform (FFT) processing, or
N-point inverse fast Fourier transform (IFFT) processing, where N is a positive integer, not a power of 2, the apparatus including:
a first circuit configured to perform butterfly operation processing for N-points of input data;
a second circuit configured to multiply each of the N-points of input data by a converted twiddle factor coefficient obtained by multiplying a twiddle factor coefficient by (M/N), where M is a power of 2; and
a third circuit configured to perform 1/M operation for N-points of output data, the multiplication of the twiddle factor coefficient by (M/N) and the 1/M operation configuring 1/N scaling to the N points of output data.

10. The signal processing apparatus according to claim 9, wherein the third circuit, in case where M is an n-th power of 2, is configured to
right-shift the output data n bits when the output data represented in a fixed-point format, or
subtract n from an exponent portion of the output data when the output data is represented in a floating-point format.
